(19) United States
(12) Patent Application Publication
(10) Pub. No.: US 2008/0095051 A1
(43) Pub. Date: Apr. 24, 2008

(54) Apparatus and method for saving resources between core network and base station controller in a mobile communication system

(75) Inventor: Kwon-Joong KIM, Seoul (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/907,886

(22) Filed: Oct. 18, 2007

(30) Foreign Application Priority Data
Oct. 18, 2006 (KR) 2006-0101182

(51) Int. Cl. G06F 11/00; H04M 1/00; H04Q 7/20

(52) U.S. Cl. 370/229; 455/456.1; 455/560

(57) ABSTRACT

An apparatus and method for saving resources between a CN and an BSC in a mobile communication system are provided. When it is determined that a calling MS and a called MS are located within a service area of the BSC and it is instructed to perform neither traffic bearer setup for the calling MS nor traffic bearer setup for the called MS between the CN and the BSC, an internal traffic path between the calling MS and the called MS is established within the BSC without performing the traffic bearer setup for the calling and called MSs.

### CROSS-REFERENCE TO RELATED PATENT APPLICATION

This application claims the benefit under 35 U.S.C. §119(a) of a Korean Patent Application No. 2006-0101182 filed on Oct. 18, 2006 in the Korean Intellectual Property Office the entire disclosure of which is hereby incorporated by reference.

### BACKGROUND OF THE INVENTION

1. Field of the Invention

The present invention relates to saving link resources between a Core Network (CN) and a Radio Network Controller (RNC) or between a Core Network (CN) and a Base Station Controller (BSC).

2. Description of the Related Art

In a Wideband Code Division Multiple Access (WCDMA) communication system, traffic connections should be established on an In interface between a CN and a RNC.

FIG. 1 illustrates a conventional communication process between User Equipments (UEs) within the same RNC.

Referring to FIG. 1, when a calling UE 130 attempts a call to a called UE 140, that is, requests a call to the called UE 140, Iu traffic connections are established for the respective UEs 130 and 140.

Even when the UEs 130 and 140 are located in the service area of the same RNC 120, the Iu traffic connections are also established for them.

If the calling UE 130 and the called UE 140 use the same Coder-Decoder (CODEC), CODEC conversion is not required in a CN 110. In this case, when an Iu-User Plane (UP) mode is a transparent mode, the CN 110 simply returns traffic received from the RNC 120 to the RNC 120. That is, the CN 110 retransmits the received traffic to the RNC 120 without any particular process.

FIGS. 2A and 2B are diagrams illustrating signal flows for the communication process between the UEs within the same RNC. While two RNCs are shown in FIGS. 2A and 2B, it is to be noted that they are an identical one.

Referring to FIGS. 2A and 2B, although the calling UE and the called UE are under the same RNC, an Iu traffic connection is established for each of the UEs. Access Link Control Application Protocol (ALCAP) is a protocol for establishing the Iu traffic connections. Iu traffic paths, such as Asynchronous Transfer Mode (ATM), Adaptation Layer 2 (AAL2) paths are established by an Establish Request (ERQ) message and an Establish Confirm (ECF) message.

In the illustrated case of FIGS. 1, 2A and 2B, even though the CN simply returns traffic received from the RNC to the RNC, the traffic connections are established between the CN and the RNC and thus the RNC and the CN perform unnecessary operations. As a result, network resources are wasted.

In a Code Division Multiple Access (CDMA) communication system, traffic connections should be established on an “A” interface between a CN and a BSC instead of Iu interface, and a role of “A” interface is almost same to that of Iu interface. Therefore, same resource waste may occur.

Accordingly, there is a need for an apparatus for saving resources between a CN and a RNC in the RNC or between a CN and a BSC in the BSC of a mobile communication system, which includes a link manager and an interface module

### SUMMARY OF THE INVENTION

An aspect of exemplary embodiments of the present invention is to address at least the problems and/or disadvantages and to provide at least the advantages described below. Accordingly, an aspect of the present invention is to provide an apparatus and method for saving resources between a CN and a BSC or between a CN and a RNC in a mobile communication system.

Another aspect of exemplary embodiments of the present invention provides an apparatus and method for enabling successful communications between a calling Mobile Station (MS) and a called MS without establishing traffic connections between a CN and a BSC or between a CN and a RNC, when the calling MS and the called MS are under the same BSC or RNC, a data mode between the CN and the BSC or between the CN and the RNC is a transparent mode, and the CN does not need to perform CODEC conversion.

According to a further aspect of exemplary embodiments of the present invention, there is provided an apparatus and method for enabling successful communications between a calling MS and a called MS through an internal traffic path of a BSC or RNC, wherein when the calling MS and the called MS are within the service area of the same BSC or RNC, a data mode between the CN and the BSC or between the CN and the RNC is a transparent mode, and the CN does not need to perform CODEC conversion.

In accordance with another aspect of exemplary embodiments of the present invention, there is provided an apparatus for saving resources between a CN and an BSC or between a CN and a RNC in the BSC or the RNC of a mobile communication system, which includes a link manager and an interface module. The link manager is positioned between the CN and the BSC or between the CN and the RNC. When it is determined that a calling MS and a called MS are located within a service area of the BSC or the RNC and it is instructed to perform neither traffic bearer setup for the calling MS nor traffic bearer setup for the called MS between the CN and the BSC or between the CN and the RNC, the link manager establishes an internal traffic path between the calling MS and the called MS without performing the traffic bearer setup for the calling and called MSs. When it is determined that the calling MS and the called MS are located within the service area of the BSC or RNC and it is instructed not to perform the traffic bearer setup for the called MS between the CN and the BSC or between the CN and the RNC, the link manager establishes the internal traffic path between the calling MS and the called MS without performing the traffic bearer setup for the called MS and releases a traffic connection for the calling MS between the BSC and the CN or between the RNC and the CN. The interface module transmits information received from the link manager to one of the calling MS, the called MS, and the CN.

Other objects, advantages, and salient features of the present invention will become apparent to those skilled in the art from the following detailed description, which, taken in conjunction with the annexed drawings, discloses exemplary embodiments of the invention.

### BRIEF DESCRIPTION OF THE DRAWINGS

The above and other objects, features and advantages of certain exemplary embodiments of the present invention will be more apparent from the following detailed description, taken in conjunction with the accompanying drawings, in which:

FIG. 1 illustrates a conventional communication process between UEs within the same RNC;

FIGS. 2A and 2B are diagrams illustrating signal flows for the communication process between the UEs within the same RNC;

FIG. 3 illustrates a communication process between UEs within the same RNC according to an exemplary embodiment of the present invention;

FIGS. 4A and 4B are diagrams illustrating signal flows for a communication process between UEs within the same RNC according to an exemplary embodiment of the present invention;

FIG. 5 is a flowchart of an operation of the RNC according to the exemplary embodiment of the present invention;

FIG. 6 is a flowchart of an operation of a CN according to the exemplary embodiment of the present invention;

FIGS. 7A and 7B are diagrams illustrating signal flows for a communication process between UEs within the same RNC according to another exemplary embodiment of the present invention;

FIG. 8 is a flowchart of an operation of the RNC according to the second exemplary embodiment of the present invention;

FIG. 9 is a flowchart of an operation of the CN according to the second exemplary embodiment of the present invention;

FIGS. 10A and 10B are diagrams illustrating signal flows for a communication process between UEs within the same RNC according to a third exemplary embodiment of the present invention;

FIG. 11 is a flowchart of an operation of the RNC according to the third exemplary embodiment of the present invention;

FIG. 12 is a flowchart of an operation of the CN according to the third exemplary embodiment of the present invention;

FIGS. 13A and 13B are diagrams illustrating signal flows for a communication process between UEs within the same RNC according to a fourth exemplary embodiment of the present invention;

FIG. 14 is a flowchart of an operation of the RNC according to the fourth exemplary embodiment of the present invention;

FIG. 15 is a flowchart of an operation of the CN according to the fourth exemplary embodiment of the present invention; and

FIG. 16 is a block diagram of a communication apparatus according to the exemplary embodiments of the present invention.

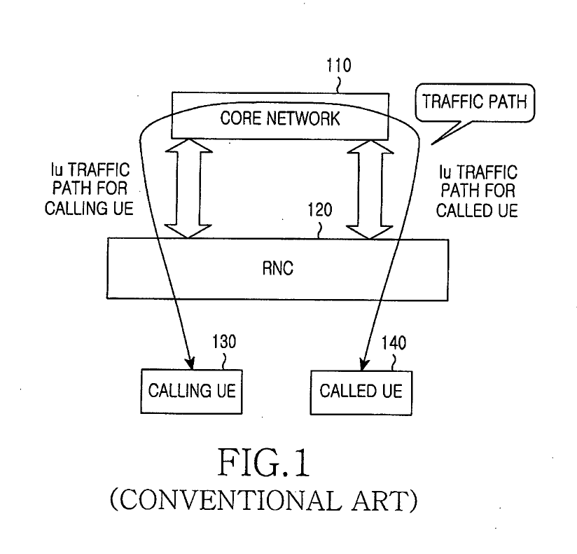

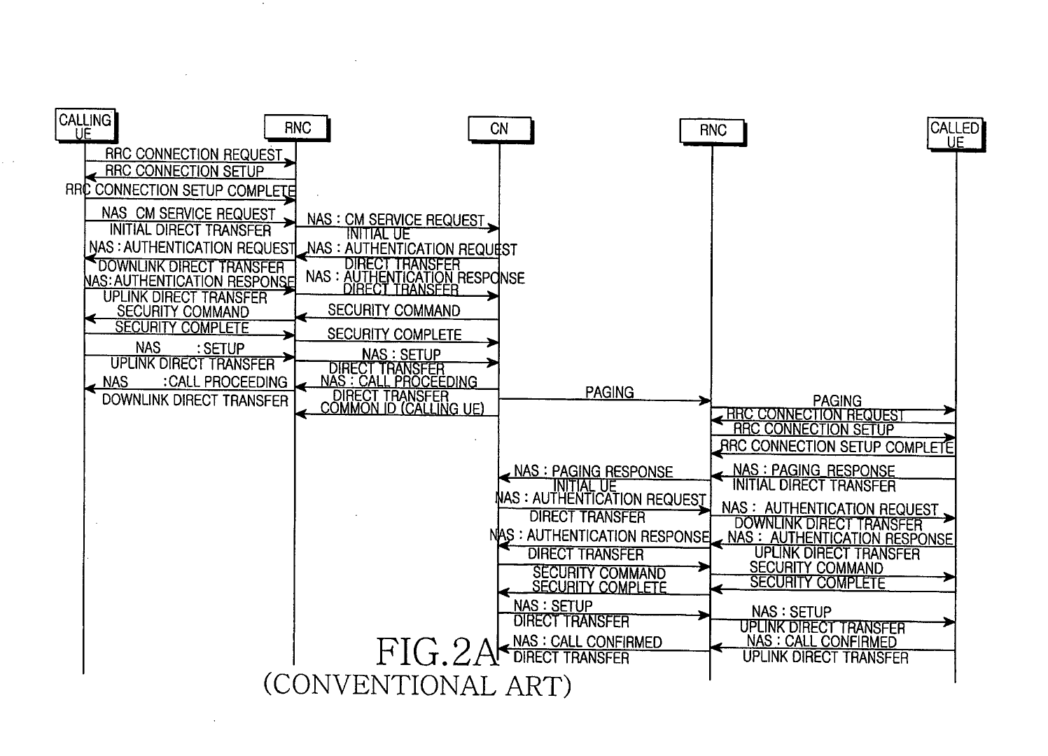

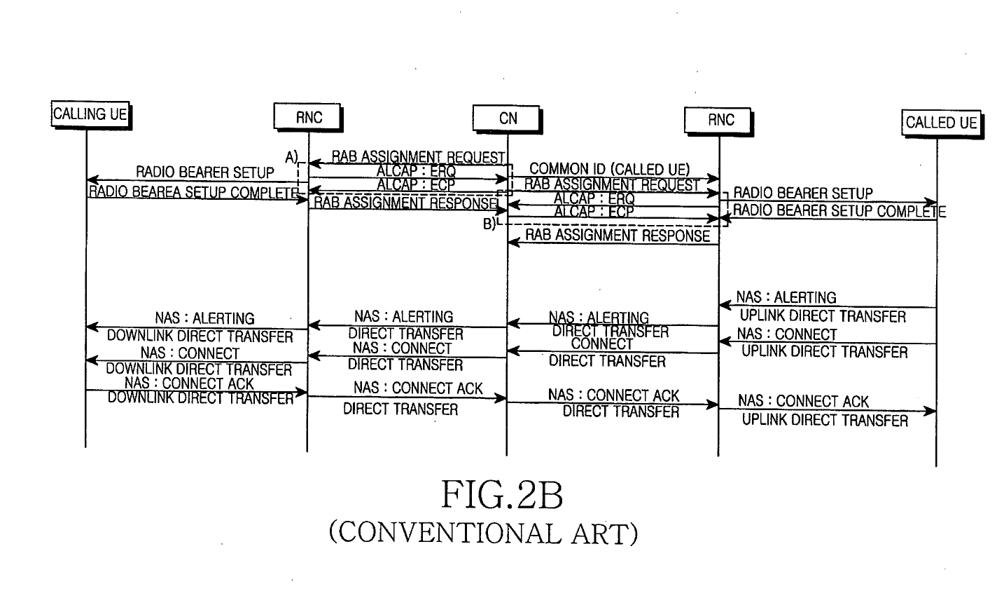

Throughout the drawings, the same drawing reference numerals will be understood to refer to the same elements, features and structures.

### DETAILED DESCRIPTION OF EXEMPLARY EMBODIMENTS

The matters exemplified in the description such as a detailed construction and elements are provided to assist in a comprehensive understanding of exemplary embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

Embodiments of the present invention are intended to provide an apparatus and method for saving link resources between a CN and a RNC in a mobile communication system.

While the present invention will be described in the context of a WCDMA communication network from 3GPP (3rd Generation Partnership Project), it is also applicable to a CDMA communication network from 3GPP2 (3rd Generation Partnership Project2). In the CDMA network, “A” interface is used instead of Iu interface, However, a role of “A” interface is almost same to that of Iu interface. Therefore, this invention is applicable to the CDMA communication network. In the CDMA network, a Mobile Station (MS) is usually used for a UE and a BSC (Base Station Controller) is usually used for a RNC. However, the MS and the UE has only a word difference not function difference and the BSC and the RNC also has only a word difference not function difference. Therefore, it is possible to use the UE, the RNC and the MS, the BSC for both communication networks.

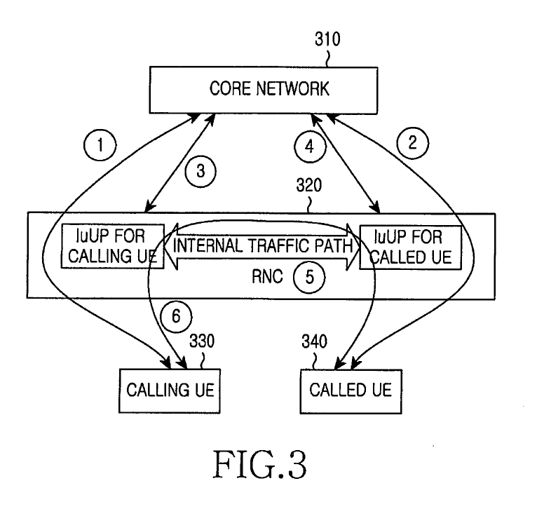

FIG. 3 illustrates a communication process between UEs within the same RNC according to an exemplary embodiment of the present invention.

Referring to FIG. 3, when a calling UE 330 and a called UE 340 are located in the service area of the same RNC 320, a CN 320 does not need to perform 10 CODEC conversion, an Iu-UP mode is a transparent mode, and user traffic from the UEs 330 and 340 is not transmitted to an Iu interface. Instead, the traffic is transmitted through an internal traffic path of the RNC 320. Therefore, resources of the Iu link are saved.

In step (1), the calling UE 330 requests a call setup to the CN 310 and the CN 310 transmits information about the International Mobile Station Identity (IMSI) of the calling UE 330 to the RNC 320 by a Common ID message. The IMSI is a 15-bit ID specific to the UE in the WCMA communication system. This ID includes a mobile country code, a mobile network code, and a mobile subscriber identification number. That is, the IMSI is unique information about the UE.

In step (2), the CN 310 transmits a paging request message to the called UE 340 and receives a paging response message for the paging request message. The CN 310 transmits the IMSI of the called UE 340 to the RNC 320 by a Common ID message, is aware that the calling UE 330 and the called UE 340 are located in the area of the same RNC 320, and determines that CODEC conversion is not required and the Iu-UP mode is a transparent mode.

In step (3), the CN 310 allocates a Radio Access Bearer (RAB) for the calling UE 330 to the RNC 320 and transmits the IMSI information of the called UE 340 to the RNC 320. The IMSI information of the called UE 340 is included in a RAB Assignment Request message or in a Common ID message. These messages are Radio Access Network Application Part (RANAP) signaling messages that are transmitted via an Iu signaling connection for the calling UE 330. The CN 310 can notify that an Iu traffic connection will not be established by the RAB Assignment Request message directed to the RNC 320.

In step (4), the CN 310 allocates a RAB for the called UE 340 to the RNC 320 and transmits the IMSI information of the calling UE 330 to the RNC 320. The IMSI information of the calling UE 330 is included in a RAB Assignment Request message or in a Common ID message. These messages are RANAP signaling messages that are transmitted via an Iu signaling connection for the called UE 340. The CN 310 can notify that an Iu traffic connection will not be established by the RAB Assignment Request message directed to the RNC 320.

In step (5), the RNC 320 manages a mapping table in which the IMSI information of the calling UE 330 is mapped to that of the called UE 340, so that traffic paths for the calling UE 330 and the called UE 340 are connected within the RNC 320.

In step (6), user traffic is transmitted through the internal path of the RNC 320 without being transmitted from the RNC 320 to the CN 310 and then being transmitted from the CN 310 to the RNC 320.

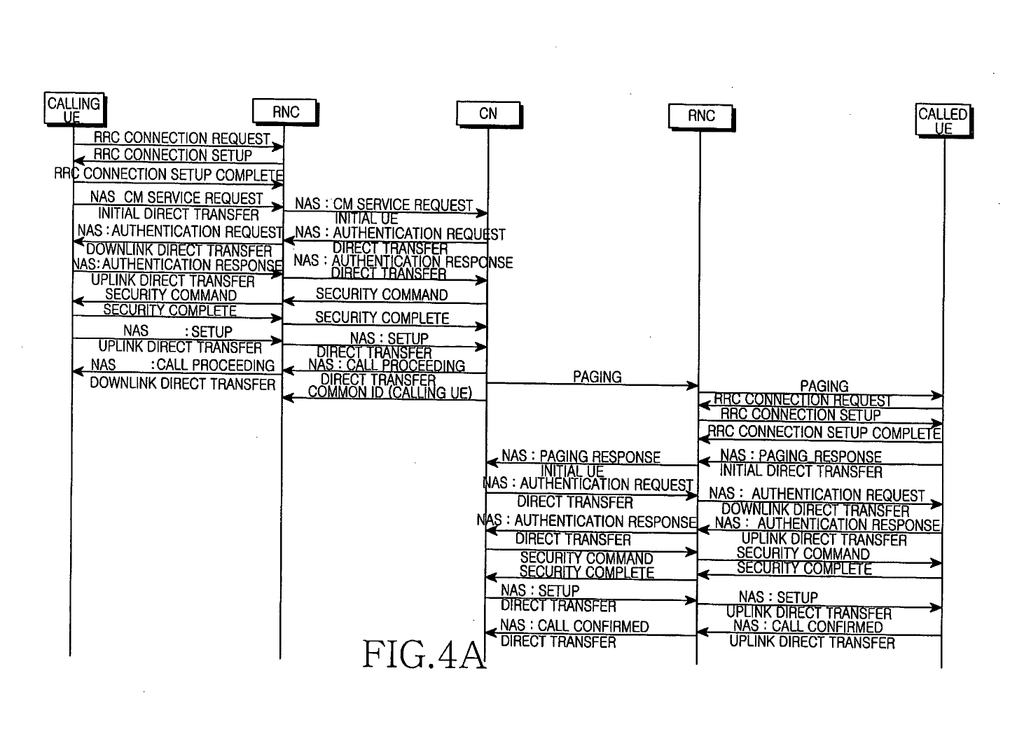

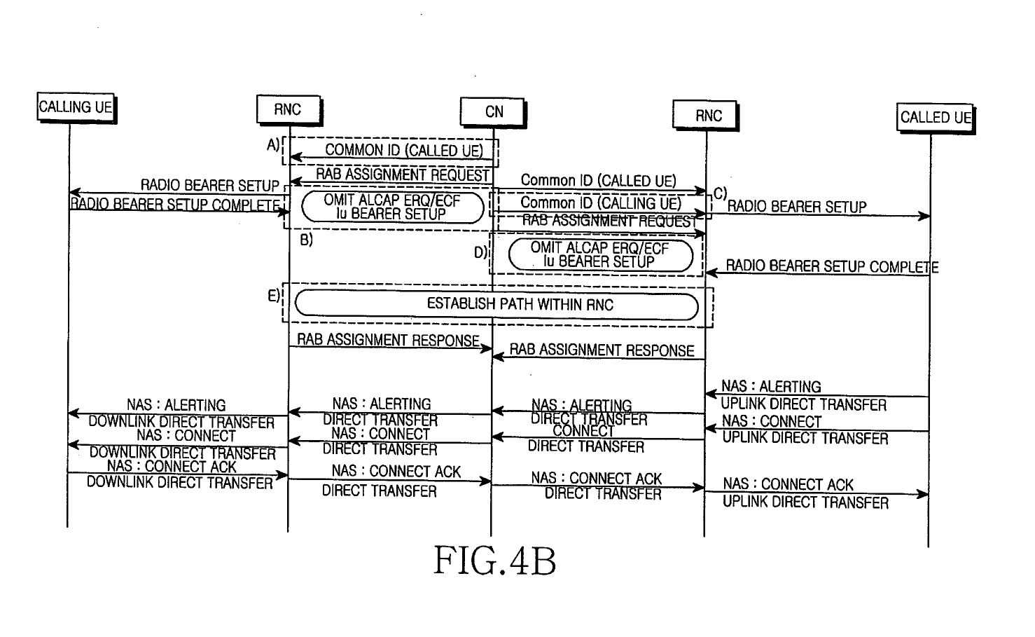

FIGS. 4A and 4B are diagrams illustrating signal flows for a communication process between UEs within the same RNC according to an exemplary embodiment of the present invention. In the illustrated case of FIGS. 4A and 4B, the IMSI of the other party is transmitted in a Common ID message.

Referring to FIGS. 4A and 4B, when an Iu signaling path for a particular UE is established between the CN and the RNC, the CN can transmit a Common ID message to the RNC for paging coordination. An Iu signaling connection is set up for each UE and thus the Common ID message carries the IMSI of the UE mapped to the Iu signaling connection.

In accordance with exemplary embodiments of the present invention, the CN transmits the IMSI of the other party UE in a second Common ID message in steps a) and c). The RNC determines from the second Common ID messages that both the calling UE and the called UE belong to it.

The RNC is aware from RAB Assignment Request messages received from the CN that Iu traffic connections will not be established and thus does not perform Iu traffic bearer setup in steps b) and d).

In step e), a traffic path between the calling UE and the called UE is established within the RNC.

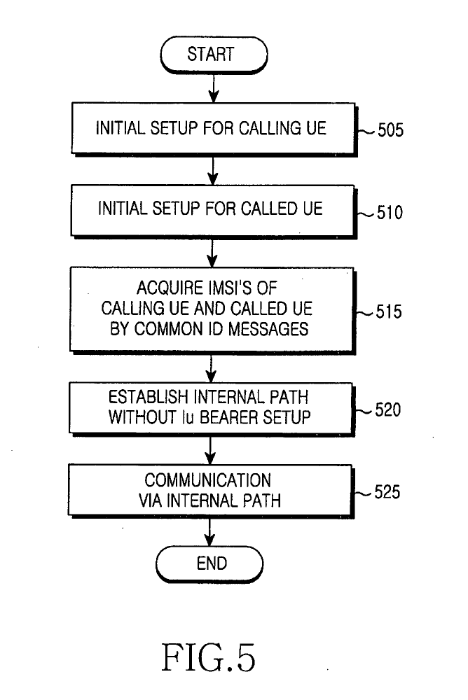

FIG. 5 is a flowchart of an operation of the RNC according to an exemplary embodiment of the present invention.

Referring to FIG. 5, upon receipt of a call request from the calling UE, the RNC performs an initial setup for the call between the calling UE and the CN in step 505. The initial setup process includes Radio Resource Control (RRC) connection, authentication, and security setting for an Iu signaling path. The calling UE's call request is transmitted to the CN through the Iu signaling path established during the initial setup.

In step 510, the CN transmits the call request to the RNC of the called UE (herein, the RNCs of the calling UE and the called UE are identical), and the RNC transmits the call request to the called UE. The RNC performs an initial setup for the call between the called UE and the CN. The initial setup process includes RRC connection, authentication, and security setting for an Iu signaling path.

In step 515, the RNC receives the IMSIs of the calling UE and the called UE in second Common ID messages from the CN and thus is aware that the calling UE and the called UE exist in the service area of the RNC.

The RNC determines from RAB Assignment Request messages received from the CN that Iu traffic connections will not be established and thus establishes a traffic path between the calling UE and the called UE within the RNC without performing Iu traffic bearer setup in step 520.

In step 525, when the called UE answers and connects the call, user traffic is transmitted via the internal traffic path of the RNC. In this manner, the call service is provided.

Then the RNC ends the algorithm.

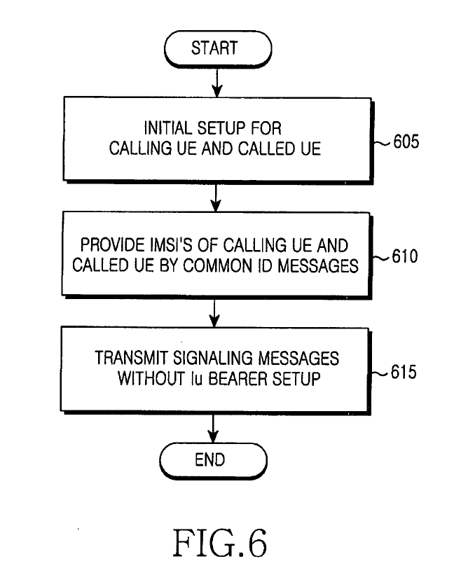

FIG. 6 is a flowchart of an operation of the CN according to an exemplary embodiment of the present invention.

Referring to FIG. 6, in step 605, when the CN receives a call request from the calling UE via the RNC, it performs an initial setup between the CN and the calling UE with the RNC, transmits the call request to the RNC of the called UE (herein, the RNCs of the calling UE and the called UE are identical), and performs an initial setup between the CN and the called UE with the RNC. The initial setup process includes RRC connection, authentication, and security setting for an Iu signaling path.

In step 610, the CN transmits the IMSIs of the calling and called UEs to the RNC by second Common ID messages so that the RNC can be aware that the calling and called UEs are within its service area.

The CN notifies the RNC that Iu traffic connections will not be established by RAB Assignment Request messages and transmits signaling information between the calling UE and the called UE to the RNC only via the established Iu signaling paths in step 615.

Then the CN ends the algorithm.

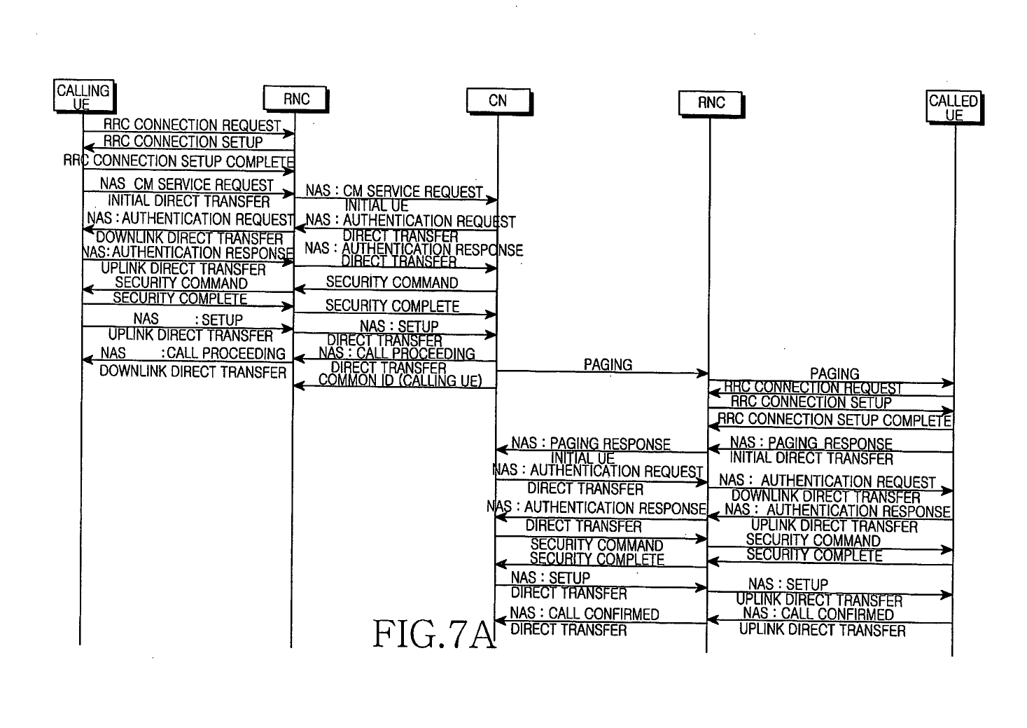

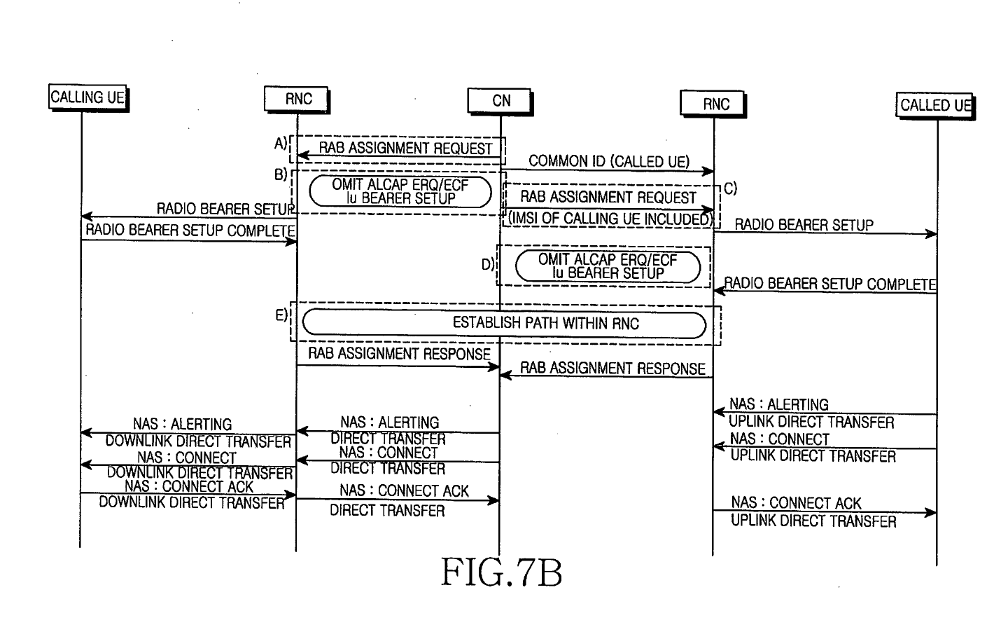

FIGS. 7A and 7B are diagrams illustrating signal flows for a communication process between UEs within the same RNC according to another exemplary embodiment of the present invention.

Referring to FIGS. 7A and 7B, compared to the communication process illustrated in FIGS. 4A and 4B, the IMSIs of the calling and called UEs are carried in RAB Assignment Request messages.

In steps a) and c), the IMSIs of the calling and called UEs are transmitted to the RNC in RAB Assignment Request messages. Thus, the RNC is aware that both the calling and called UEs are within its service area.

Also, the RNC determines from the RAB Assignment Request messages that Iu traffic connections will not be established and thus does not perform Iu traffic bearer setup in steps b) and d).

In step e), a traffic path between the calling UE and the called UE is established within the RNC.

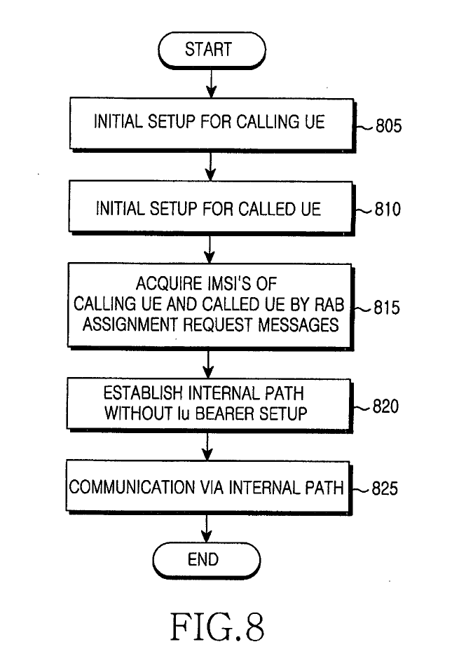

FIG. 8 is a flowchart of an operation of the RNC according to the second exemplary embodiment of the present invention.

Referring to FIG. 8, upon receipt of a call request from the calling UE, the RNC performs an initial setup for the call between the calling UE and the CN in step 805. The initial setup process includes RRC connection, authentication, and security setting for an Iu signaling path. The calling UE's call request is transmitted to the CN through the Iu signaling path established during the initial setup.

In step 810, the CN transmits the call request to the RNC of the called UE (herein, the RNCs of the calling UE and the called UE are identical), and the RNC transmits the call request to the called UE. The RNC performs an initial setup for the call between the called UE and the CN. The initial setup process includes RRC connection, authentication, and security setting for an Iu signaling path.

In step 815, the RNC receives the IMSIs of the calling UE and the called UE in RAB Assignment Request messages from the CN and thus is aware that the calling UE and the called UE exist in the service area of the RNC. The RNC also determines from the RAB Assignment Request messages that Iu traffic connections will not be established and thus establishes a traffic path between the calling UE and the called UE within the RNC without performing Iu traffic bearer setup in step 820.

In step 825, when the called UE answers and connects the call, user traffic is transmitted via the internal traffic path of the RNC. In this manner, the call service is provided.

Then the RNC ends the algorithm.

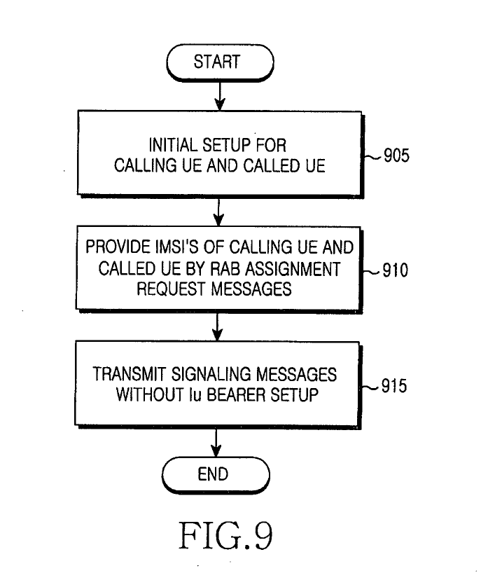

FIG. 9 is a flowchart of an operation of the CN according to the second exemplary embodiment of the present invention.

Referring to FIG. 9, in step 905, when the CN receives a call request from the calling UE via the RNC, it performs an initial setup between the CN and the calling UE with the RNC, transmits the call request to the RNC of the called UE (herein, the RNCs of the calling UE and the called UE are identical), and performs an initial setup between the CN and the called UE with the RNC. The initial setup process includes RRC connection, authentication, and security setting for an Iu signaling path.

In step 910, the CN transmits the IMSIs of the calling and called UEs to the RNC by RAB Assignment Request messages, so that the RNC can be aware that the calling and called UEs are within its service area. The CN also notifies the RNC that Iu traffic connections will not be established by the RAB Assignment Request messages.

In step 915, the CN transmits signaling information between the calling UE and the called UE to the RNC only via the established Iu signaling paths.

Then the CN ends the algorithm.

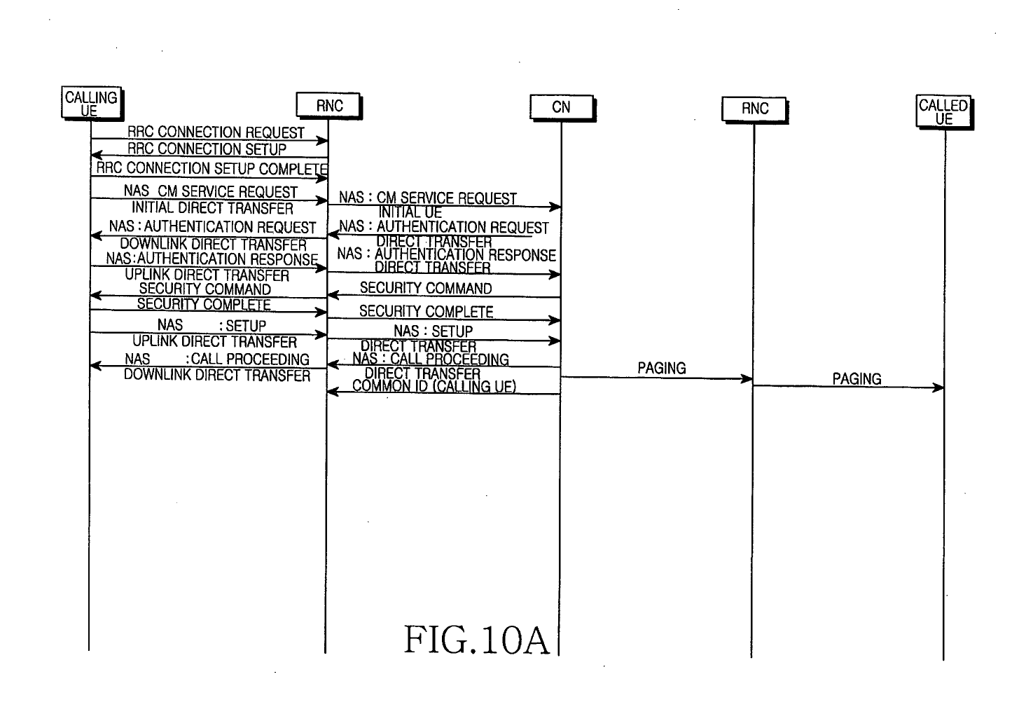

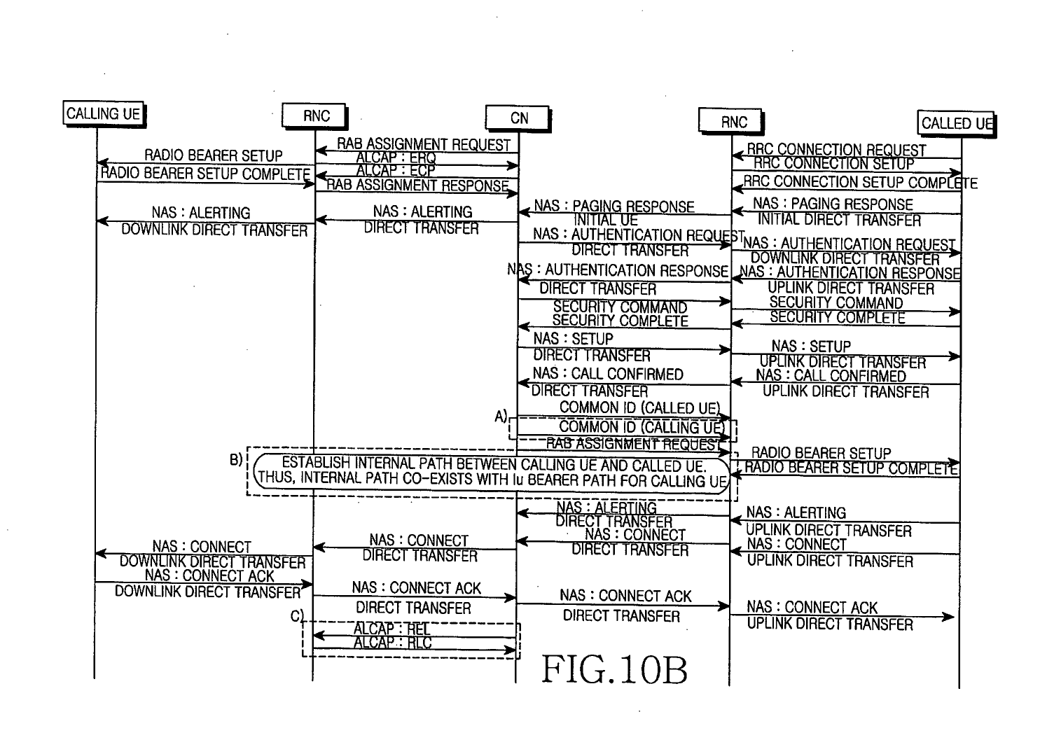

FIGS. 10A and 10B are diagrams illustrating signal flows for a communication process between UEs within the same RNC according to a third exemplary embodiment of the present invention.

Referring to FIGS. 10A and 10B, the CN performs Alerting for the calling UE irrespective of a response for a call request from the called UE.

In step a), upon receipt of the IMSI of the calling UE in a second Common ID message from the CN via an Iu signaling connection established for the called UE, the RNC is aware that both the calling and called UEs are within its service area. As the RNC determines from a RAB Assignment Request message received from the CN that an Iu traffic connection for the called UE will not be established, it establishes an internal path without performing Iu traffic bearer setup (ERQ/ECF) for the called UE in step b).

When the CN receives a NAS: Connect Ack message from the calling UE, it releases an Iu traffic connection for the calling UE in step c) because the Iu traffic connection for the calling UE was established between the CN and the RNC before the Alerting. For the connection release, Release Request (REL) and Release Confirm (RLC) messages being ALCAP messages are used.

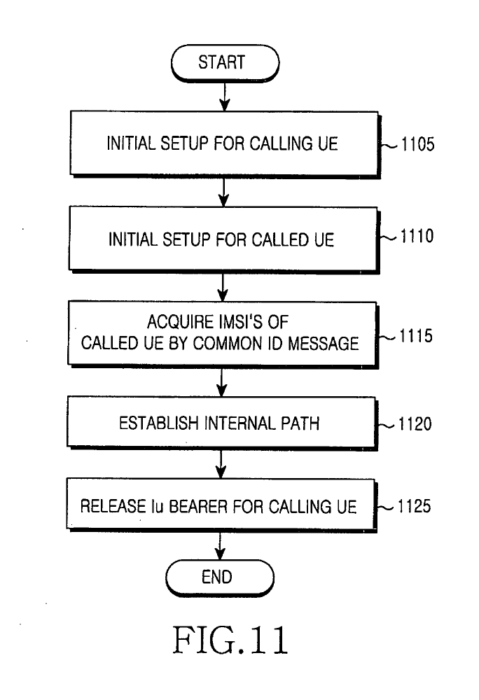

FIG. 11 is a flowchart of an operation of the RNC according to the third exemplary embodiment of the present invention.

Referring to FIG. 11, upon receipt of a call request from the calling UE, the RNC performs an initial setup for the call between the calling UE and the CN in step 1105. The initial setup process includes RRC connection, authentication, and security setting for an Iu signaling path. The calling UE's call request is transmitted to the CN through the Iu signaling path established during the initial setup.

In step 1110, the CN transmits the call request to the RNC of the called UE (herein, the RNCs of the calling UE and the called UE are identical), and the RNC transmits the call request to the called UE. The RNC performs an initial setup for the call between the called UE and the CN. The initial setup process includes RRC connection, authentication, and security setting for an Iu signaling path.

In step 1115, the RNC receives the IMSI of the calling UE in a second Common ID message from the CN via the Iu signaling connection established for the called UE and thus is aware that the calling UE and the called UE exist in the service area of the RNC.

In step 1120, the RNC also determines from a RAB Assignment Request message that an Iu traffic connection for the called UE will not be established and thus establishes a traffic path between the calling UE and the called UE within the RNC without performing Iu traffic bearer setup (ERQ/ECF) for the called UE.

In step 1125, since an Iu traffic connection for the calling UE was established between the CN and the RNC, the RNC releases the Iu traffic connection. In this case, as the called UE answers the call, the call is connected and the CN receives a NAS: Connect Ack message from the calling UE.

Then the RNC ends the algorithm.

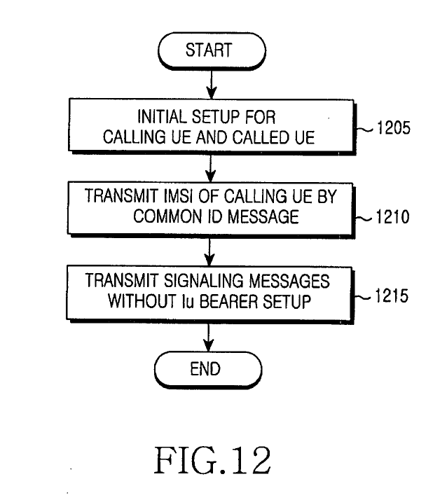

FIG. 12 is a flowchart of an operation of the CN according to the third exemplary embodiment of the present invention.

Referring to FIG. 12, in step 1205, when the CN receives a call request from the calling UE via the RNC, it performs an initial setup between the CN and the calling UE with the RNC, transmits the call request to the RNC of the called UE (herein, the RNCs of the calling UE and the called UE are identical), and performs an initial setup between the CN and the called UE with the RNC. The initial setup process includes RRC connection, authentication, and security setting for an Iu signaling path.

In step 1210, the CN transmits the IMSI of the calling. UE to the RNC by a second Common ID message. That is, besides a conventional Common ID message with the IMSI of the called UE, the CN transmits an additional Common ID message with the IMSI of the calling UE to the RNC so that the RNC is aware that the calling and called UEs are within its service area.

In step 1215, the CN notifies the RNC that an Iu traffic connection for the called UE will not be established by a RAB Assignment Request message and transmits signaling information between the calling UE and the called UE to the RNC only via the established Iu signaling paths. If the called UE answers the call and thus the call is connected, upon receipt of receipt of a NAS: Connect Ack message from the calling UE, the CN releases an Iu traffic connection for the calling UE because the Iu traffic connection for the calling UE has been established between the RNC and the CN before Alerting. For the connection release, REL and RLC messages being ALCAP messages are used.

Then the CN ends the algorithm.

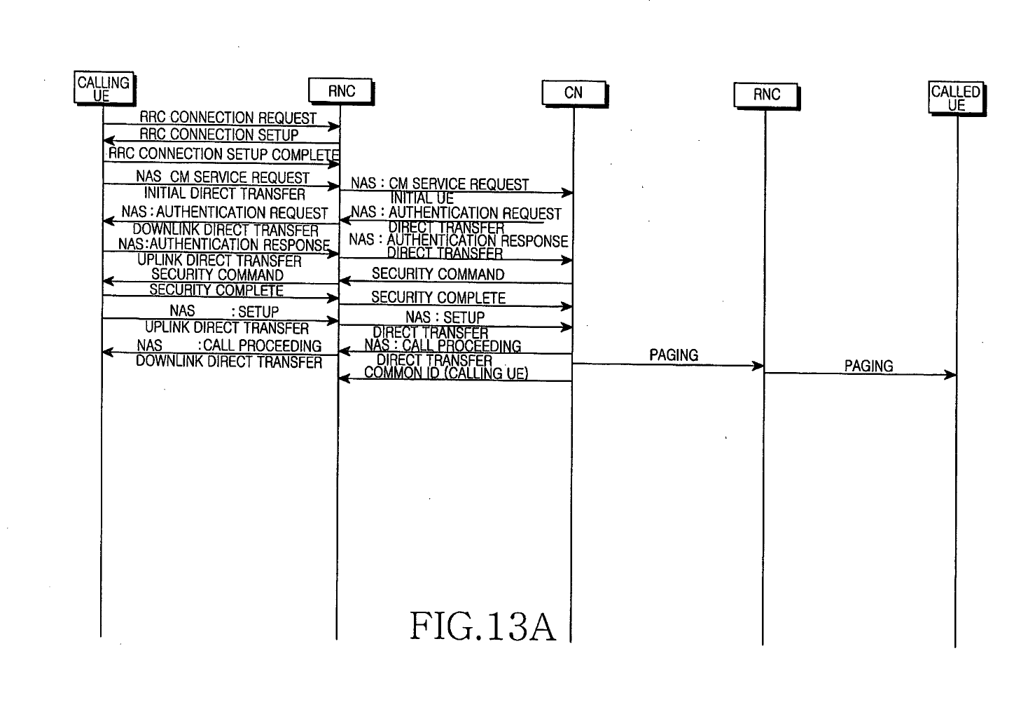

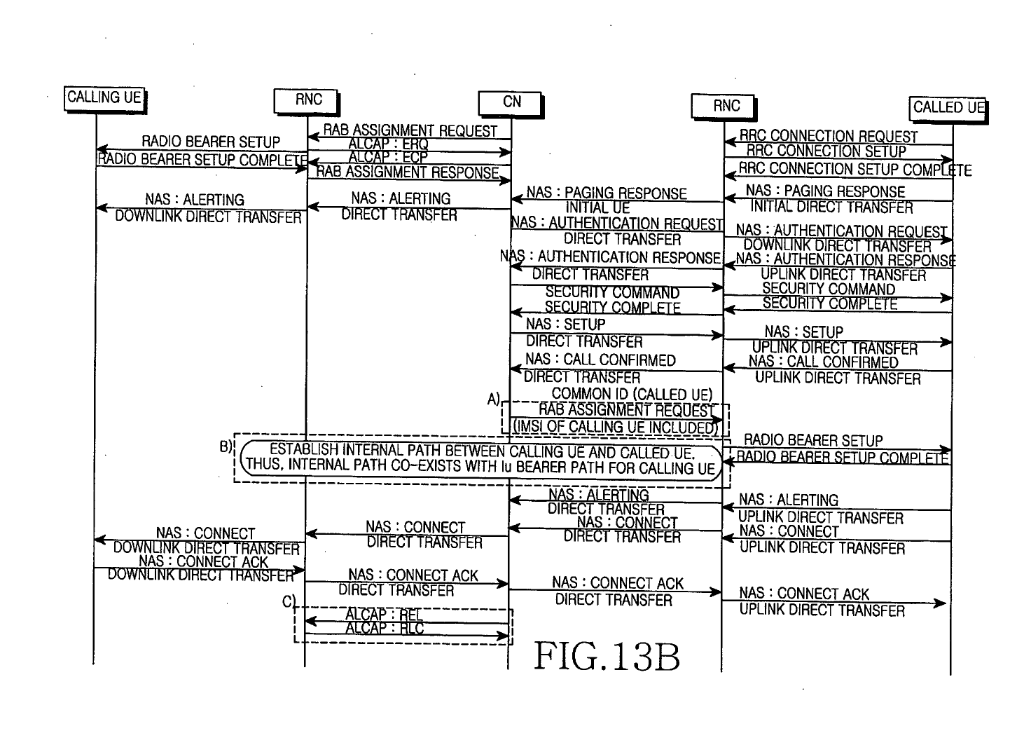

FIGS. 13A and 13B are diagrams illustrating signal flows for a communication process between UEs within the same RNC according to a fourth exemplary embodiment of the present invention.

Referring to FIGS. 13A and 13B, compared to the communication process illustrated in FIGS. 10A and 10B, the IMSI of the other party is carried in a RAB Assignment Request message.

The CN performs Alerting for the calling UE irrespective of a response for a call request from the called UE.

In step a), upon receipt of the IMSI of the calling UE in a RAB Assignment Request message from the CN via an Iu signaling connection established for the called UE, the RNC is aware that both the calling and called UEs are within its service area.

As the RNC also determines from the RAB Assignment Request message received from the CN that an Iu traffic connection for the called UE will not be established, it establishes an internal path without performing Iu traffic bearer setup (ERQ/ECF) for the called UE in step b).

When the CN receives a NAS: Connect Ack message from the calling UE, it releases an Iu traffic connection for the calling UE in step c) because the Iu traffic connection for the calling UE was established between the CN and the RNC before the Alerting. For the connection release, REL and RLC messages being ALCAP messages are used.

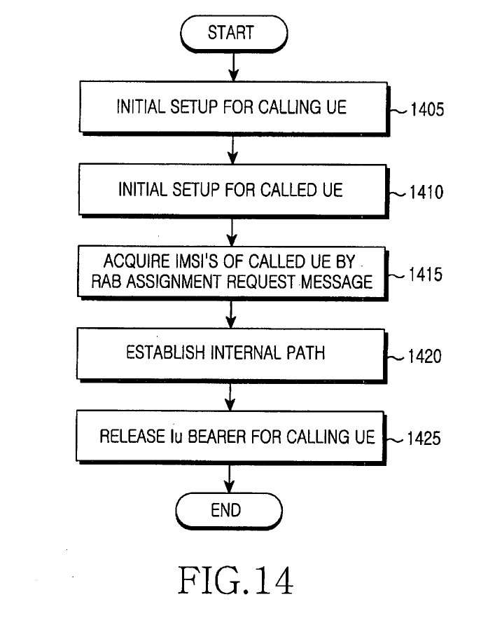

FIG. 14 is a flowchart of an operation of the RNC according to the fourth exemplary embodiment of the present invention.

Referring to FIG. 14, upon receipt of a call request from the calling UE, the RNC performs an initial setup for the call between the calling UE and the CN in step 1405. The initial setup process includes RRC connection, authentication, and security setting for an Iu signaling path. The calling UE's call request is transmitted to the CN through the Iu signaling path established during the initial setup.

In step 1410, the CN transmits the call request to the RNC of the called UE (herein, the RNCs of the calling UE and the called UE are identical), and the RNC transmits the call request to the called UE. The RNC performs an initial setup for the call between the called UE and the CN. The initial setup process includes RRC connection, authentication, and security setting for an Iu signaling path.

In step 1415, the RNC receives the IMSI of the calling UE in a RAB Assignment Request message from the CN via the Iu signaling connection established for the called UE and thus is aware that the calling UE and the called UE exist in the service area of the RNC.

Determining from the RAB Assignment Request message that an Iu traffic connection for the called UE will not be established, the RNC establishes a traffic path between the calling UE and the called UE within the RNC without performing Iu traffic bearer setup (ERQ/ECF) for the called UE in step 1420.

In step 1425, since an Iu traffic connection for the calling UE was established between the CN and the RNC, the RNC releases the Iu traffic connection. In this case, as the called UE answers the call, the call is connected and the CN receives a NAS: Connect Ack message from the calling UE.

Then the RNC ends the algorithm.

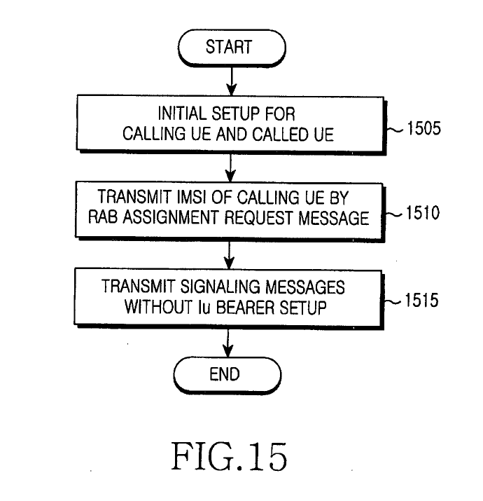

FIG. 15 is a flowchart of an operation of the CN according to the fourth exemplary embodiment of the present invention.

Referring to FIG. 15, in step 1505, when the CN receives a call request from the calling UE via the RNC, it performs an initial setup between the CN and the calling UE with the RNC, transmits the call request to the RNC of the called UE (herein, the RNCs of the calling UE and the called UE are identical), and performs an initial setup between the CN and the called UE with the RNC. The initial setup process includes RRC connection, authentication, and security setting for an Iu signaling path.

In step 1510, the CN transmits the IMSI of the calling UE to the RNC by a RAB Assignment Request message. That is, besides a conventional Common ID message with the IMSI of the called UE, the CN transmits a RAB Assignment Request message with the IMSI of the calling UE to the RNC so that the RNC is aware that the calling and called UEs are within its service area The CN also notifies the RNC that an Iu traffic connection for the called UE will not be established by the RAB Assignment Request message.

Thus, the CN transmits signaling information between the calling UE and the called UE to the RNC only via the established Iu signaling paths in step 1515. If the called UE answers and connects the call, upon receipt of receipt of a NAS: Connect Ack message from the calling UE, the CN releases an Iu traffic connection for the calling UE because the Iu traffic connection for the calling UE has been established between the RNC and the CN before Alerting. For the connection release, REL and RLC messages being ALCAP messages are used.

Then the CN ends the algorithm.

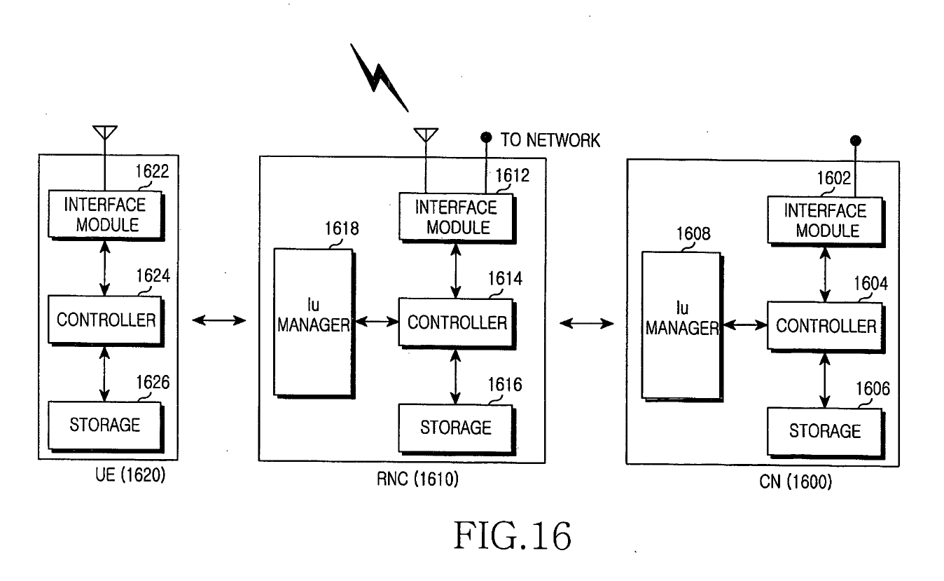

FIG. 16 is a block diagram of a communication apparatus according to exemplary embodiments of the present invention.

Referring to FIG. 16, the communication apparatus includes a RNC 1610, a CN 1600, and a UE 1620. The following description is focused on the RNC 1610 and the CN 1600 which are within the scope of the embodiments of the present invention. Thus, a detailed description of the UE 1620 and its components is not provided herein.

In the RNC 1610, an interface module 1612 is a module for communicating with another node. It includes a Radio Frequency (RF) processor and a baseband processor. The RF processor downconverts an RF signal received through an antenna to a baseband signal and provides the baseband signal to the baseband processor. The baseband processor upconverts a baseband signal to an RF signal transmittable in the air and transmits the RF signal through the antenna. The interface module 1612 further includes a wired communication module for communicating with the CN 1600.

A controller 1614 provides overall control to the RNC 1610. For example, the controller 1614 processes and controls voice call and data communication. In addition to the typical functionalities, the controller 1614 controls an Iu manager 1618 not to perform an Iu traffic bearer setup with the CN 1600 and establish an internal traffic path, for a communication service, when a calling UE and a called UE are located within the service area of the RNC 1610 according to an exemplary embodiment of the present invention.

When the calling UE and the called UE use the same CODEC, the CN 1600 does not need to perform CODEC conversion, an Iu-UP mode is a transparent mode, and IMSI information received from the CN 1600 indicates that the calling UE and the called UE are located in the service area of the RNC 1610, the Iu manager 1618 establishes the internal traffic path without the Iu traffic bearer setup between the CN 1600 and the RNC 1610 under the control of the controller 1610.

When the calling UE and the called UE use the same CODEC, the CN 1600 does not need to perform CODEC conversion, an Iu-UP mode is a transparent mode, IMSI information received from the CN 1600 indicates that the calling UE and the called UE are located in the service area of the RNC 1610, and the CN 1600 carries out alerting for the calling UE irrespective of a response for a call request from the called UE, the Iu manager 1618 does not perform an Iu traffic setup for the called UE, releases an existing Iu traffic connection for the calling UE between the RNC 1610 and the CN 1600, and establishes the internal traffic path under the control of the controller 1610.

A storage 1616 stores programs for controlling the overall operation of the RNC 1610 and temporary data generated during program execution.

The controller 1614 may incorporate the function of the Iu manager 1618, while they are separately configured in FIG. 16 for better understanding of their separate functions. In real implementation, the function of the Iu manager 1618 can be wholly or partially incorporated into the controller 1614.

In the CN 1600, an interface module 1602 is a module for communicating with another node. It includes a wired communication module for communicating with the RNC 1610 and other network entities.

A controller 1604 provides overall control to the CN 1600. For example, the controller 1614 processes and controls voice call and data communication. In addition to the typical functionalities, when the calling and called UEs are located in the service area of the RNC 1610, the controller 1614 controls an Iu manager 1618 to provide IMSI information of the calling UE and the called UE to the RNC so that the RNC 1610 is aware that the calling and called UEs are located in its service area and establishes an internal traffic path without an Iu traffic bearer setup with the CN 1600, for a communication service.

When the calling UE and the called UE use the same CODEC, the CN 1600 does not need to perform CODEC conversion, an Iu-UP mode is a transparent mode, and IMSI information received from the CN 1600 indicates that the calling UE and the called UE are located in the service area of the RNC 1610, the Iu manager 1608 notifies the RNC 1610 that the calling and called UEs are within the service area of the RNC 1610 under the control of the controller 1604, so that the RNC 1610 establishes the internal traffic path without the Iu traffic bearer setup between the CN 1600 and the RNC 1610.

When the calling UE and the called UE use the same CODEC, the CN 1600 does not need to perform CODEC conversion, an Iu-UP mode is a transparent mode, the calling UE and the called UE are located in the service area of the RNC 1610, and the CN 1600 carries out alerting for the calling UE irrespective of a response for a call request from the called UE, the controller 1610 controls the Iu manager 1608 not to perform an Iu traffic setup for the called UE and release an existing Iu traffic connection for the calling UE between the RNC 1610 and the CN 1600, so that the RNC 1610 establishes the internal traffic path.

A storage 1606 stores programs for controlling the overall operation of the CN 1600 and temporary data generated during program execution.

The controller 1604 may incorporate the function of the Iu manager 1608, while they are separately configured in FIG. 16 for better understanding of their separate functions. In real implementation, the function of the Iu manager 1608 can be wholly or partially incorporated into the controller 1604.

As is apparent from the above description, exemplary embodiments of the present invention advantageously maximize the utilization of link resources by enabling communications between a calling UE and a called UE through an internal path of a RNC, when the calling UE and the called UE are located within the service area of the RNC.

While the present invention has been shown and described with reference to certain embodiments of the present invention thereof, they are mere exemplary applications. Therefore, it will be understood by those skilled in the art that various changes in form and details may be made therein without departing from the spirit and scope of the present invention as defined by the appended claims and their equivalents.

What is claimed is:

1. An apparatus for saving resources between a Core Network (CN) and a Base Station Controller (BSC) in the BSC of a mobile communication system, the apparatus comprising:
a link manager between the CN and the BSC, for, when it is determined that a calling Mobile Station (MS) and a called MS are located within a service area of the BSC and it is instructed to perform neither traffic bearer setup for the calling MS nor traffic bearer setup for the called MS between the CN and the BSC, establishing an internal traffic path between the calling MS and the called MS without performing the traffic bearer setup for the calling and called MSs, and when it is determined that the calling MS and the called MS are located within the service area of the BSC and it is instructed not to perform the traffic bearer setup for the called MS between the CN and the BSC, establishing the internal traffic path between the calling MS and the called MS without performing the traffic bearer setup for the called MS and releasing a traffic connection for the calling MS between the BSC and the CN; and
an interface module for transmitting information received from the link manager to one of the calling MS, the called MS, and the CN.

2. The apparatus of claim 1, wherein if as the calling MS and the called MS use the same Coder-Decoder (CODEC), the CN does not need CODEC conversion and data is transparently transmitted, the link manager establishes the internal traffic path between the calling MS and the called MS without establishing a link between the CN and the BSC.

3. The apparatus of claim 1, wherein the link manager determines from unique information about one of the calling MS and the called MS included in a common identifier (ID) message received from the CN that the calling MS and the called MS are located within the service area of the BSC.

4. The apparatus of claim 1, wherein the link manager determines from unique information about one of the calling MS and the called MS included in a radio access bearer (RAB) assignment request message received from the CN that the calling MS and the called MS are located within the service area of the BSC.

5. The apparatus of claim 1, wherein when it is instructed by a RAB assignment request message received from the CN to perform neither traffic bearer setup for the calling MS nor traffic bearer setup for the called MS between the CN and the BSC, the link manager does not perform the traffic bearer setup for the calling and called MSs.

6. The apparatus of claim 1, wherein when it is instructed by a RAB assignment request message received from the CN not to perform the traffic bearer setup for the called MS between the CN and the BSC, the link manager does not perform the traffic bearer setup for the called MS.

7. The apparatus of claim 1, wherein upon receipt of a request for releasing the traffic connection for the calling MS between the CN and the BSC from the CN, the link manager releases the traffic connection.

8. An apparatus for saving resources between a Core Network (CN) and a Base Station Controller (BSC) in the CN of a mobile communication system, the apparatus comprising:
a link manager between the CN and the BSC, for, when a calling Mobile Station (MS) and a called MS are located within a service area of the BSC, notifying the BSC that the calling MS and the called MS are located within the service area of the BSC, instructing the BSC to perform neither traffic bearer setup for the calling MS nor traffic bearer setup for the called MS between the CN and the BSC, and when the calling MS and the called MS are located within the service area of the BSC, notifying the BSC that the calling MS and the called MS are located within the service area of the BSC, instructing the BSC not to perform the traffic bearer setup for the called MS between the CN and the BSC, and releasing a traffic connection for the calling MS between the BSC and the CN; and
an interface module for transmitting information received from the link manager to one of the BSC and other network entities.

9. The apparatus of claim 8, wherein if as the calling MS and the called MS use the same Coder-Decoder (CODEC), the CN does not need CODEC conversion and data is transparently transmitted, the link manager notifies the BSC that the calling MS and the called MS are located within the service area of the BSC and instructs the BSC not to perform one of traffic bearer setup for the calling MS and traffic bearer setup for the called MS between the CN and the BSC

10. The apparatus of claim 8, wherein the link manager notifies the BSC that the calling MS and the called MS are located within the service area of the BSC by transmitting unique information about one of the calling MS and the called MS in a common identifier (ID) message.

11. The apparatus of claim 8, wherein the link manager notifies the BSC that the calling MS and the called MS are located within the service area of the BSC by transmitting unique information about one of the calling MS and the called MS in a Radio Access Bearer (RAB) assignment request message.

12. The apparatus of claim 8, wherein the link manager instructs the BSC by a RAB assignment request message to perform neither traffic bearer setup for the calling MS nor traffic bearer setup for the called MS between the CN and the BSC.

13. The apparatus of claim 8, wherein the link manager instructs the BSC by a RAB assignment request message not to perform the traffic bearer setup for the called MS between the CN and the BSC.

14. The apparatus of claim 8, wherein upon receipt of a connect acknowledgement (Ack) message from the calling MS, the link manager releases the traffic connection for the calling MS between the BSC and the CN.

15. A method for saving resources between a Core Network (CN) and a Base Station Controller (BSC) in the BSC of a mobile communication system, the method comprising:
determining whether a calling Mobile Station (MS) and a called MS are located within a service area of the BSC; and
establishing, when the calling MS and the called MS are located within the service area of the BSC and it is instructed to perform neither traffic bearer setup for the calling MS nor traffic bearer setup for the called MS between the CN and the BSC, an internal traffic path between the calling MS and the called MS without performing the traffic bearer setup for the calling and called MSs.

16. The method of claim 15, further comprising, when the calling MS and the called MS are located within the service area of the BSC and it is instructed not to perform the traffic bearer setup for the called MS between the CN and the BSC,
establishing the internal traffic path between the calling MS and the called MS without performing the traffic bearer setup for the called MS; and
releasing a traffic connection for the calling MS between the BSC and the CN.

17. The method of claim 16, further comprising establishing the internal traffic path between the calling MS and the called MS without establishing a link between the CN and the BSC, if as the calling MS and the called MS use the same Coder-Decoder (CODEC), the CN does not need CODEC conversion and data is transparently transmitted.

18. The method of claim 16, wherein the determination comprises determining from unique information about one of the calling MS and the called MS included in a common identifier (ID) message received from the CN that the calling MS and the called MS are located within the service area of the BSC.

19. The method of claim 16, wherein the determination comprises determining from unique information about one of the calling MS and the called MS included in a radio access bearer (RAB) assignment request message received from the CN that the calling MS and the called MS are located within the service area of the BSC.

20. The method of claim 16, further comprising not performing the traffic bearer setup for the calling and called MSs, when it is instructed by a RAB assignment request message received from the CN to perform neither traffic bearer setup for the calling MS nor traffic bearer setup for the called MS between the CN and the BSC.

21. A method for saving resources between a Core Network (CN) and a Base Station Controller (BSC) in the CN of a mobile communication system, the method comprising:
determining whether a calling Mobile Station (MS) and a called MS are located within a service area of the BSC;
notifying the BSC that the calling MS and the called MS are located within the service area of the BSC, if the calling MS and the called MS are located within the service area of the BSC; and
instructing the BSC to perform neither traffic bearer setup for the calling MS nor traffic bearer setup for the called MS between the CN and the BSC.

22. The method of claim 21, further comprising:
instructing the BSC not to perform the traffic bearer setup for the called MS between the CN and the BSC; and
releasing a traffic connection for the calling MS between the BSC and the CN.

23. The method of claim 22, further comprising, if as the calling MS and the called MS use the same Coder-Decoder (CODEC), the CN does not need CODEC conversion and data is transparently transmitted, notifying the BSC that the calling MS and the called MS are located within the service area of the BSC and instructing the BSC not to perform one of traffic bearer setup for the calling MS and traffic bearer setup for the called MS between the CN and the BSC

24. The apparatus of claim 22, wherein the notification comprises notifying the BSC that the calling MS and the called MS are located within the service area of the BSC by transmitting unique information about one of the calling MS and the called MS in a common identifier (ID) message.

25. The method of claim 22, wherein the notification comprises notifying the BSC that the calling MS and the called MS are located within the service area of the BSC by transmitting unique information about one of the calling MS and the called MS in a Radio Access Bearer (RAB) assignment request message.
